(19) United States
(12) Patent Application Publication
(10) Pub. No.: US 2021/0084109 A1
(43) Pub. Date: Mar. 18, 2021

(54) CONTENT MANAGEMENT SYSTEM

(71) Applicant: Hewlett-Packard Development Company, L.P., Spring, TX (US)

(72) Inventors: Galo Gimenez Palop, Boise, ID (US); Eduardo Argollo de Oliveira Dias Junior, Vancouver, WA (US)

(73) Assignee: Hewlett-Packard Development Company, L.P., Spring, TX (US)

(21) Appl. No.: 16/970,529

(22) PCT Filed: Apr. 16, 2018
(86) PCT No.: PCT/US2018/027760

§ 371 Date: Aug. 17, 2020

(51) Int. Cl. H04L 29/08; H04L 29/06; H04W 12/02

(52) U.S. Cl. CPC H04L 67/2819; H04L 63/0428; H04L 65/4084; H04W 12/02; H04L 63/105

(57) ABSTRACT

A content management system to implement a privacy policy is disclosed. A call is received regarding a transfer of data between services. Metadata corresponding to the data is verified. The privacy policy is applied to the metadata to determine whether the transfer of data can be completed.

### BACKGROUND

A service-oriented architecture, often abbreviated SOA, is a style of software application implementation in which software components provide services to other components via a communication protocol over a computer network. A service is typically a discrete unit of functionality that can be accessed remotely and acted upon and updated independently. Different services can be used in conjunction together to provide a larger software application. Service-oriented architectures typically emphasize application composition by integrating distributed, separately maintained and deployed software components. Microservices are a relatively new realization and implementation approach to service oriented architecture and emphasize continuous deployment and other agile practices to build distributed software systems. Microservices is a variant of the service-oriented architecture architectural in that it structures an application as a collection of loosely coupled services. Microservices typically use technology agnostic protocols that aid in encapsulating choice of language and frameworks making the language and framework a concern internal to the service. Microservices are typically fine-grained and include lightweight protocols, which can improve modularity and make the application easier to understand, develop and test and can parallelize development by enabling small autonomous teams to develop, deploy and scale the respective services independently and also enable continuous delivery and deployment.

### BRIEF DESCRIPTION OF THE DRAWINGS

FIG. 1 is a block diagram illustrating an example method.

FIG. 2 is a block diagram illustrating an example content management system to implement the example method of FIG. 1.

FIG. 3 is a block diagram illustrating an example system to implement the example method of FIG. 1 or the example content management system of FIG. 2.

### DETAILED DESCRIPTION

Microservices based applications are distinguishable from monolithic or three-tier applications. One example of a microservices application is a cloud native application, which is implemented in cloud computing frameworks that include loosely-coupled cloud services. The cloud native architecture typically includes features in addition to microservices such as containers that provide resource isolation and dependency management and an orchestrator that provides the underlying hardware into a homogenous pool. These features provide cloud native applications with mechanisms to scale under load and handle failures in the cloud environment. In an example of a microservices based application, each service can be independently deployable and scalable, and typically manages its own dataset or subset of application data. A service often can transfer data between services of the application.

The collection, use and transfer of data are subject to laws and regulations that can be regionally or vertically imposed by governments. Examples of laws and regulation governing the transfer of data include the Health Insurance Portability and Accountability Act, or HIPAA, and the Sarbanes-Oxley Act, or SOX, in the United States and the European Global Data Protection Regulation, or EU GDPR, in the European Union. Each data set may be subjected to specific rules depending on whether the data includes, for example, personal data, Personal Identifiable Information (PII), Personal Credit Information (PCI), or personal health information. In the example of systems and software, a content management system can store many types of data records, but the applicable data policies may be different if the data record includes personal information or personal health information. In another example, some data records such as name or date of birth for European citizens might not be allowed to be stored on servers outside of the European Union.

Attempts to manage the collection, use, and transfer of data in modern application architectures have been a challenge. Policies regarding data management are traditionally implemented in the application logic, which leads to several issues. For example, if the individual application or service is used to manage the data policies, the policies may be difficult to update and management consistently across the distributed application. Additionally, the lack of visibility of the control makes difficult the determination of which policies are being applied and where the policies are affected. Still further, some software may not be easily adapted to new regulations. Infrastructures for applications based on microservices or cloud native applications can apply controls to the service itself, but the controls typically do not affect the data. For example, infrastructure or platform services that implement traffic routing may send traffic to a specific service backend based on a particular request attribute, such as the origin of the request, but the control is applied without knowledge or regard of the underlying data being transferred.

An example of a relatively recent infrastructure or platform service to implement service-to-service communication for applications in the microservices architecture, including cloud native applications, is a service mesh. A service mesh, in one example, is an infrastructure networking system that can assume a layer above TCP/IP (Transmission Control Protocol and Internet Protocol) to deliver requests between services. In one implementation, a service mesh includes an array of lightweight network proxies that are deployed alongside application code. An example of a typical cloud native application may include hundreds of services or thousands of instances with an orchestrator that reschedules instances from moment to moment, and the path of a request through the service topology can be complex. A service mesh decouples the communication from the application code and manages the dynamic environment of the application.

A typical example of a service mesh includes a data plane and control plane. Services are operably coupled to the service mesh to send communications in the form of requests between the services. Data flows between services in the data plane. Also the data plane reports information about each message in a transactions between services. The control plane causes specific actions to occur on the data plane using policies across service to data.

An example policy management system can be implemented as a service to interface with the service mesh. The example content management system includes a privacy policy and a repository of privacy-policy related metadata for the data records of the services. The privacy policy is affected with the control plane. In one example, the data plane intercepts calls regarding the transfer of data between services. The control plane calls the content management system and verifies the metadata applied to the privacy policy to determine whether the request may be completed, such as whether data from one server located in the EU can be transferred to a server located in the U.S. based on a privacy policy linked to GDPR. The control plane enforces an action regarding the data transfer based on the privacy policy. In the example, the control plane may stop the data transfer or find the corresponding data on another server in the U.S. for transfer to the U.S. server and complete the data transfer.

The example content management system includes several advantages over other attempts to manage data policy based regulations. Two of these advantages are provided. First, the content management system provides for centralized policy enforcement and management to allow for more direct policy reactions and updates to changes in the regulations and for consistency across the application. Further, policies applied to the data are made visible and can be audited at relatively low cost. Further, the visibility of the enforcement provides for additional data and analytics.

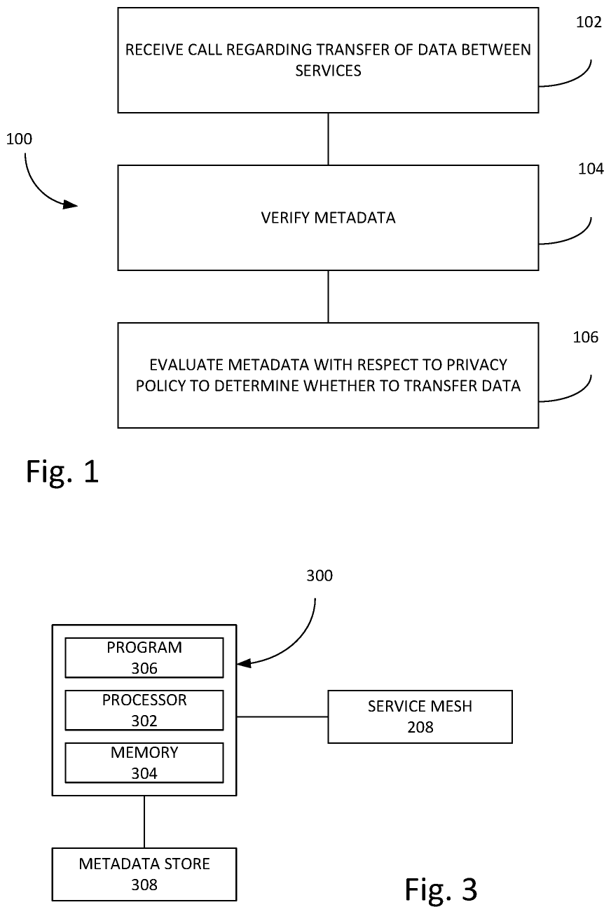

FIG. 1 illustrates an example method 100 to implement a privacy policy. The example method can be applied to a plurality of services communicating with a service mesh. A call regarding a transfer of data between the services is received at 102. For example, the data plane of the service mesh intercepts the call between the services, and the control plane provides the call. Metadata corresponding to the data is verified at 104. The metadata is related to a privacy policy such as legal zone of the location of the data or the type of data such as whether the data is personal information. Metadata corresponding to the data records of the data being transferred can be stored in a metadata repository. The metadata regarding the privacy policy is evaluated with respect to the privacy policy. Whether the transfer can be completed based on the metadata applied to a privacy policy is determined at 106. In one example, the action of the privacy policy, such as whether the transfer can be completed, is enforced with the control plane.

Method 100 can be implemented as part of a service coupled to the service mesh to provide the receiving of the call at 102, verifying the metadata at 104, and determining of whether the transfer can be completed at 106. The service may be included as part of an infrastructure as a service or platform as a service via a cloud provider along with the service mesh, or the service may be available separately from the service mesh. The example method 100 can be implemented to include a combination of one or more hardware devices and computer programs for controlling a system, such as a computing system having a processor and memory, to perform method 100 to implement a privacy policy. Examples of computing system can include a server such as a server blade in a datacenter, and can also include workstation, a mobile device such as a tablet or smartphone, a personal computer such as a laptop, and a consumer electronic device, or other device. Method 100 can be implemented as a computer readable medium or computer readable device having set of executable instructions for controlling the processor to perform the method 100.

Examples of a computer storage medium, or a non-transitory computer readable medium, includes volatile or nonvolatile memory devices such as RAM, ROM, EEPROM, flash memory, optical storage and magnetic storage technology, that can be used to store the desired information and that can be accessed by a computing system. Accordingly, a propagating signal by itself does not qualify as a storage medium. Computer readable medium may be located with a computing system communicatively connected a service mesh or infrastructure or platform service. Method 100 can be applied as a computer program, or computer application implemented as a set of instructions stored in the memory, and the processor can be configured to execute the instructions to perform a specified task or series of tasks. In one example, the computer program can make use of functions either coded into the program itself or as part of library also stored in the memory.

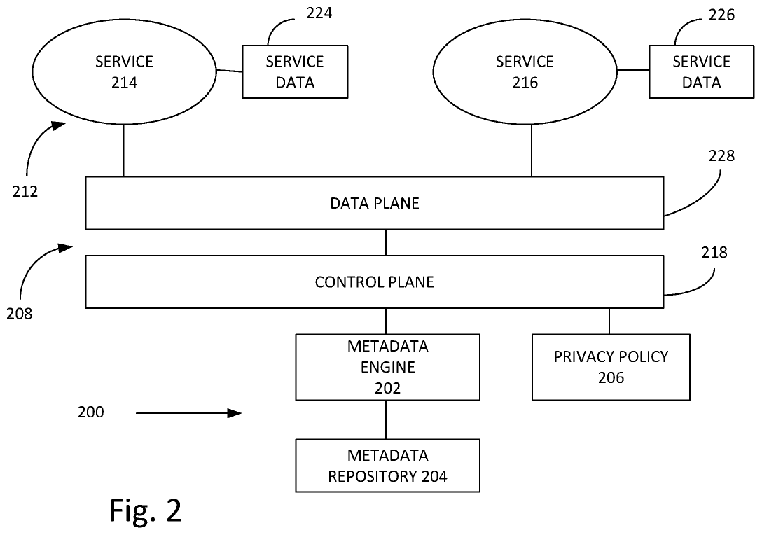

FIG. 2 illustrates an example content management system 200 that can be used to implement method 100. The example content management system 200 includes a metadata engine 202 operably coupled to a metadata repository 204 and a privacy policy 206. The metadata engine 202 is configured to receive the call at 102 and verify the metadata at 104 from the metadata repository 204 and evaluate the privacy policy 206 to determine whether the transfer can be completed at 106. In the example, the content management system 200 is included in an environment that can include a service mesh 208 to enforce the privacy policy 206 on a microservices-based application. In one example, the content management system 200 is included as a service for a microservices-based application.

The content management system 200 is illustrated in an example environment including a plurality of services 212, of which two services 214, 216 are illustrated. The services 212, in one example, may be included in a cloud native application or other microservices-based application. The illustrated services 214, 216 can include service datasets 224, 226, respectively, which include data records for use by service calls that may be transferred to other services via requests. The services 212 are operably coupled together with an infrastructure or platform layer including an example service mesh 208 that provides delivery of requests between services 212. The example service mesh 208 includes a control plane 218 and a data plane 228. The control plane 218 applies general policies across the services 202. The data plane 228 reports information about each message transaction between services 212 to the control plane 218, and the control plane 218 requests actions occur on the data plane 228, such as preventing access or rerouting the request. Message transactions in the data plane 228 can include data records from the data sets 224, 226 as well as attributes, such as HTTP headers or security token claims, that can include information about the application, user profile, and destination service scope. Messages may also include context, like the source of the request or destination of the request. Attributes and context can be used to evaluate polices or drive decisions in the control plane 218.

The content management system 200, in the example, can include a service that extends the control plane 218 and stores and retrieves metadata about the data records in the datasets 224, 226. For example, the metadata can include location information about the datasets 224, 226 and privacy policy related metadata about each data record. The metadata repository 204 can be configured as a key value store that includes the metadata about the data records in the datasets 224, 226. In one example, the key can be the record identifier, or record ID, which can correspond with a data record in the datasets 224, 226. The value can include the metadata about each data record.

A data regulation, such as the examples of HIIPA, SOX, and GDPR, can be implemented as a privacy policy 206 that is stored and executed at the control plane 218 along with general policies. The privacy policy can be crafted to comply with a selected regulation or other selected rule and is driven by the selected regulation or the selected rule. In response to a service request, a proxy in the service mesh 208 can send the request attributes and context to the control plane 218, which will evaluate the policy to be used. The privacy policy 206 will be executed at the control plane 218 if the attributes and context, such as originator and destination, of the service request implicates the privacy policy 206. The privacy policy 206 can evaluate the attributes and context, and extract the record ID. The record ID can be provided to the metadata engine 202 to look up the corresponding metadata in the metadata repository 204. The metadata engine 204 can determine an appropriate action based on the privacy policy 206 applied to the metadata in the metadata repository 204. The action can be provided to the control plane 218 and enforced.

For example, the metadata for a data record could include a data type of the data record. If a record is tagged with metadata having data type as PCI, the action could be to limit access to services or clients that are PCI compatible or to administrators that have been granted PCI access. If a record is tagged with metadata having data type as personal data, the access limitation may be different than if the record is tagged as PCI or personal health information.

In another example, the metadata for a data record could include a jurisdiction of the data record, such as a country, state, province, region or other legal zone. The privacy policy 206 in the example could include an aspect or rule that documents originated in a first country are not to be sent to a second country. The control plane 218 could receive an intercepted request from the data plane 228 in which the attributes and context of the request implicate the privacy policy 206, such as origination and destination information. The control plane 218 could call the metadata engine 202 to verify the legal zone metadata of the record as stored in the metadata repository 204 that the request could not be provided by a host in the first country.

The metadata repository 204 can store metadata properties with the record ID to permit the evaluation of the privacy policy 206. Two such metadata properties that typically can apply to a privacy policy include data type and jurisdiction type, or legal zone type. Examples of data types can include general data, personal data, PCI, and personal health information. The jurisdiction types can be applied to the location of the data record, the location of the user identified in the data record. Examples of jurisdiction types can include the country, state, province, and region of the record or the individual identified in the record. In one example, the type of data and the jurisdiction are considered together in a privacy policy. For instance, a record have a selected type of data may not be implicated unless a particular type of jurisdiction has a regulation on that type of data. Other metadata properties that could be stored to correspond with a record ID include an instance in which the record is stored, a user identifier of the user that created the record, a tenant identifier to identify the tenant in which the record was created, and a timestamp indicating when the record was created.

Granularity of the metadata properties can vary from the entire dataset 224, 226 to each individual data field in the datasets. In one example, each service 212 can manage a dataset of a specific type. In this example, each dataset 224, 226 can include a data of the similar type, such as data type and jurisdiction type. The data records in each dataset 224, 226 in this example can thus include the same metadata properties. More granular classifications are contemplated.

Metadata regarding the datasets 224, 226 can be populated in the metadata repository 204 in a variety of ways. For example, the service mesh 208 can be used to populate the metadata. Features of the service mesh 208 can be used to create, modify, or delete the metadata. In this example, metadata in the records can be extracted by the control plane 218 via a POST or PUT command, and a policy specific to the service mesh 208 can populate the metadata repository 204 such as a policy that can understand how to extract a record ID. Additionally, the metadata engine 202 can include a mechanism, such as an application programming interface (API) to create, modify, or delete metadata records. In one example, the metadata engine 202 is accessible from outside of the control plane 218.

FIG. 3 illustrates an example system 300 to implement method 100 and the content management system 200 or features of method 100 and system 200. The system 300 includes computing device having a processor 302 and memory 304. Depending on the configuration and type of computing device of system 300, memory 304 may be volatile (such as random access memory (RAM)), non-volatile (such as read only memory (ROM) or flash memory), or some combination of the two. The system 300 can take one or more of several forms such as a server in a datacenter. The memory 304 can store at least method 100 as set of computer executable instructions 306 for controlling the computer system 300 to perform features of method 100. System 300 can include an operating system to manage the system 300. The system 300 can include communication connections to communicate with other systems or computer applications such as the service mesh 208. Also for example, the metadata repository 204 and privacy policy may also be stored in memory 304 or located in a communicatively coupled memory storage, such as on a persistent memory device 308 networked with the system 300.

In an example, method 100 and content management system 200 are implemented in system 300 as a particular infrastructure configuration of the datacenter (or over a set of datacenters) such as in virtual machine, which abstracts hardware of the system 300, or a container, which abstracts the operating system of the system 300. Cloud native applications can be deployed in containers. One example of a container is a sidecar container. In one example, a service 212 can be extended in a proxy sidecar container to manage inbound and outbound communications and a control plane 218 and metadata engine 202 are each included in separate nodes operably coupled to the service 212. In this example, the control plane 218 can be used to populate the metadata repository 204. In another example, the metadata engine 202 is deployed as a sidecar container to the service 212, and the control plane deployed in a separate node that is operably coupled to a proxy and the metadata engine 202. In this example, the service 212 can interact with the metadata engine directly to create, update, and delete metadata.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method for a content management system, the method comprising:
receiving a call regarding a transfer of data between a plurality of services;
verifying metadata corresponding to the data; and
determining whether the transfer can be completed based on the metadata applied to a privacy policy.

2. The method of claim 1 wherein the metadata is stored in a metadata repository.

3. The method of claim 2 wherein the metadata repository includes a key value store that includes metadata about data records used by the services.

4. The method of claim 1 wherein the transfer of data between the services is included in a service mesh.

5. The method of claim 4 wherein the service mesh includes a data plane to intercept the call regarding the transfer of data and a control plane to evaluate the privacy policy.

6. The method of claim 1 and comprising enforcing an action regarding the transfer of data based on the privacy policy.

7. The method of claim 6 wherein enforcing the action includes completing the transfer of data.

8. A non-transitory computer readable storage device to store computer executable instructions to control a processor to:
receive a call regarding a transfer of data between a plurality of services;
verify metadata corresponding to the data; and
determine whether the transfer can be completed based on the metadata applied to a privacy policy.

9. The computer readable storage device of claim 8 implemented as a service operably coupled to a service mesh to transfer the data.

10. The computer readable storage device of claim 9 wherein the services are included in a cloud native application.

11. The computer readable storage device of claim 8 wherein the metadata includes a legal zone in which the data is stored and a privacy type of the data.

12. A content management system, comprising:
a memory device to store a set of instructions; and
a processor to execute the set of instructions to:
receive a call regarding a transfer of data between a plurality of services;
verify metadata corresponding to the data; and
determine whether the transfer can be completed based on the metadata applied to a privacy policy.

13. The content management system of claim 12 wherein the transfer of data between the services is included in a service mesh, the service mesh including a control plane to enforce the privacy policy and call the content management system.

14. The content management system of claim 13 wherein the service mesh includes a data plane to intercept the call regarding the transfer of data between the plurality of services.

15. The content management system of claim 12 including a metadata repository to store the metadata corresponding with the data.
